(19) United States
(12) Patent Application Publication
(10) Pub. No.: US 2018/0196928 A1
(43) Pub. Date: Jul. 12, 2018

(54) NETWORK VISUALIZATION FOR ACCESS CONTROLS

(71) Applicant: Conjur, Inc., Waltham, MA (US)

(72) Inventors: Kevin Gilpin, Weston, MA (US); J. Mitchell Haile, Somerville, MA (US)

(21) Appl. No.: 15/522,329

(22) PCT Filed: Sep. 12, 2016
(86) PCT No.: PCT/US2016/051240

§ 371 Date: Apr. 27, 2017

Related U.S. Application Data
(60) Provisional application No. 62/216,576, filed on Sep. 10, 2015.

(51) Int. Cl. G06F 21/31; G06F 21/60; H04L 29/06; G06F 9/455

(52) U.S. Cl. CPC G06F 21/31; G06F 21/604; G06F 2009/45591; G06F 9/45558; H04L 63/20

(57) ABSTRACT

Network visualization of access controls is utilized to manage computing resources in a computing environment. Host computing systems, virtual nodes executing on the host computing systems, end users associated with each host computing system and virtual node, and permissions for each 5 end user are identified. A display of the computing environment is then generated and comprises interconnections between visual representations of the host computing systems, the virtual nodes, the end users, and the secrets. Modifying data can update, simplify and alter the display.

### RELATED APPLICATIONS

This application hereby claims the benefit of and priority to U.S. Provisional Patent Application 62/216,576, entitled “NETWORK GRAPH FOR VISUALIZING ACCESS CONTROLS,” filed 10 Sep. 2015, and which is hereby incorporated by reference in its entirety.

### TECHNICAL FIELD

Aspects of the disclosure are related to the field of access control in computing environments and, in particular, monitoring access to secrets in a computing environment.

### TECHNICAL BACKGROUND

Virtualization techniques have gained popularity and are now commonplace in data centers and other computing environments in which it is useful to increase the efficiency with which computing resources are used. In a virtualized environment, one or more virtual nodes are instantiated on an underlying host computer and share the resources of the underlying computer. Rather than implementing a single node per host computing system, multiple nodes may be deployed on a host to more efficiently use the processing resources of the computing system. These virtual nodes may include full operating system virtual machines, Linux containers, such as Docker containers, jails, or other similar types of virtual containment nodes.

In some implementations, computing environments may “spin up” and “spin down” processing nodes and services as they are required. For example, when a user requires a virtual machine, processing resources may be allocated to the end user and a virtual machine may be initiated on a host computing system. This new virtual machine may then be provided with permissions based on the identity of the end user requesting the new virtual machine. These permissions may include network permissions, disk access permissions, permissions to sensitive information, such as passwords, usernames, and the like, or any other similar computing permission. However, as the computing environment becomes more complex, managing and identifying the various access permissions of virtual nodes and end users can become difficult and burdensome.

### OVERVIEW

Non-limiting examples described herein provide enhancements for managing resources in a computing environment. In one implementation, a method of managing computing resources in a computing environment includes identifying host computing systems in the computing environment, and identifying virtual nodes executing on the host computing systems. The method further provides identifying end users associated with each host computing system and virtual node, and identifying secret permissions for each of the end users to secrets in the computing environment. The method also includes generating a display of the computing environment, wherein the display comprises interconnections between visual representations of the host computing systems, the virtual nodes, the end users, and the secrets.

In another implementation, a management system for managing computing resources in a computing environment includes one or more computer readable media. The system further includes processing instructions stored on the one or more computer readable media that, when executed by a processing system, direct the processing system to identify host computing systems in the computing environment, and identify virtual nodes executing on the host computing systems. End users associated with each host computing system and virtual node are also identified, as are permissions for each of the end users to secrets in the computing environment. A display of the computing environment is then generated based on the identified resources and/or information, wherein the display comprises interconnections between visual representations of the host computing systems, the virtual nodes, the end users, and the secrets.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a computing environment to generate a visual overview of a computing environment according to one implementation.

FIG. 2 illustrates a user interface generated by a visualization system to visualize interactions in a computing environment according to one implementation.

FIG. 3 illustrates a method of generating a visual overview of a computing environment according to one implementation.

FIG. 4 illustrates a computing system to generate a visual overview of a computing environment according to one implementation.

### DESCRIPTION

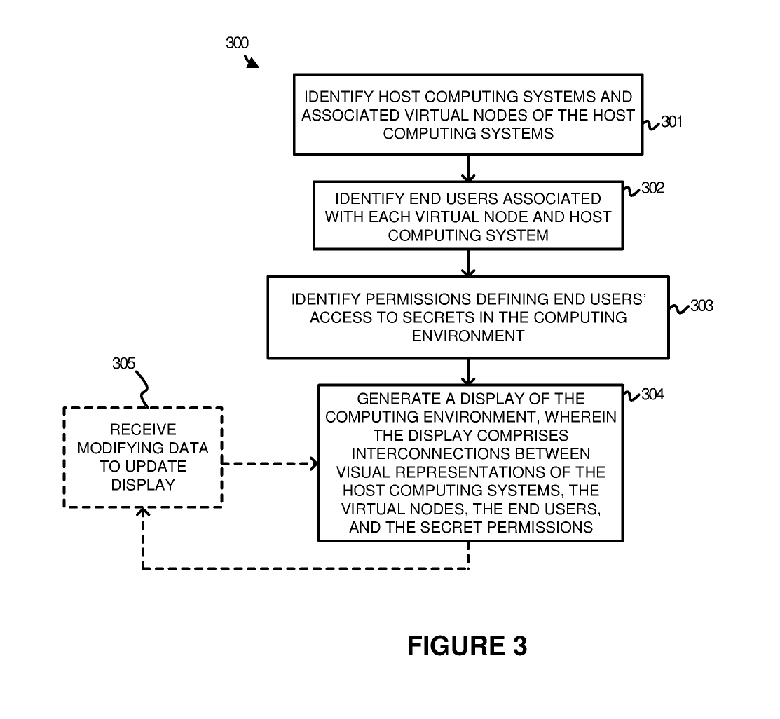

Network content, such as web page content, typically includes content such as text, hypertext markup language (HTML) pages, pictures, video, audio, animations, code, scripts, or other content viewable by an end user in a browser or other application. This various network content can be stored and served by origin servers and equipment. The network content includes example website content referenced in FIG. 3, such as “www.gamma.gov,” “www.alpha.com,” and “www.beta.net,” among others. In some examples, origin servers can serve the content to end user devices. However, when a content delivery system is employed, the content delivery system can act as a proxy to cache content between origin servers and the end user devices.

The various figures and descriptions included herein discuss many examples for enhanced operational management of computing resources. In many computing networks, host computing systems are initiated that provide a platform for a variety of virtual nodes. These virtual nodes may include full operating system virtual machines, Linux containers, such as Docker containers, jails, or other similar types of virtual containment nodes. As more hosts and virtual nodes are initiated in the environment, it may become difficult for administrators and other end users within the environment to identify the computing systems accessible to the individual users, as well as the secrets (e.g., sensitive or “secret” data) that are accessible to the individual users. This secret data may include any sensitive data of an end user of an environment, a customer of the environment, or any other similar user or organization. The secret data may include usernames, passwords, encrypted files, or any other similar secret data within the computing environment.

To manage the computing environment with multiple host computing systems and associated virtual nodes, a visualization system may be provided that identifies the permissions of the computing environment and provides those to a user interface system along with other identified resources and/or information. In particular, the visualization system, which may comprise a physical computing system, an application, a virtual node, and/or any other system may be configured to monitor the permissions of the computing resources within the environment. This monitoring of permissions may include identifying the host computing systems executing in the environment, identifying the virtual nodes executing in the environment (e.g., virtual nodes executing on identified host computing systems), identifying users associated with the identified hosts and virtual nodes, and identifying permissions to identified secrets (e.g., access to secret data for each end user). Based on the information gathered for the computing resources in the computing environment, the visualization system may generate a graphical or other display on a user interface system or the like that can be used to show relationships (e.g., interconnections) between visual representations of computing resources (hosts and virtual nodes), users of the computing environment, and secrets available within the computing environment.

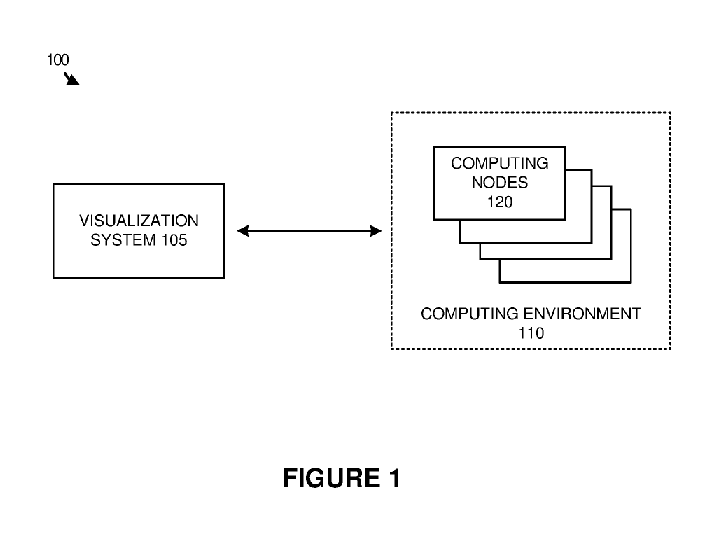

To further demonstrate the observation of interactions within the computing environment, FIG. 1 is provided. FIG. 1 illustrates a computing environment 100 to generate a visual overview of a computing environment according to one implementation. Computing environment 100 includes visualization system 105 and computing nodes 120 and can constitute or include a management system for managing the environment 100. Visualization system 105 may comprise one or more physical computing systems, full operating system virtual machine, containers, or some other similar computing systems. Computing nodes 120 can comprise host computing systems and virtual nodes. Virtual nodes may include full operating system virtual machines, Linux containers, such as Docker containers, jails, or other similar types of virtual containment nodes.

In operation, visualization system 105 collects information about computing environment 110 and computing nodes 120. This information may include identifiers for the host computing systems of the environment, the virtual nodes executing on each of the hosts, the users associated with each host and virtual node, the secret data available to each of the users, and/or other data. Based on the information collected, visualization system 105 generates a display of computing environment 110 (e.g., a map, tree, listing, model and/or other depiction), wherein the display depicts the interaction of the computing resources, the users associated with each resource, and the secrets associated with each user.

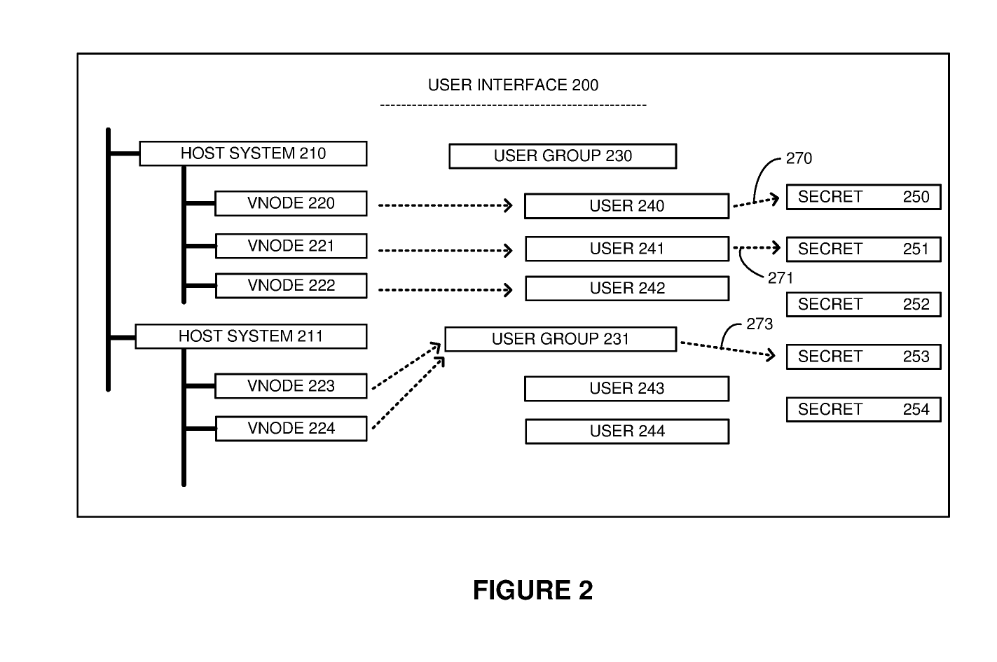

Referring now to FIG. 2, a user interface 200 generated by a visualization system illustrates interactions in a computing environment according to one implementation. User interface 200 is a non-limiting sample graphical representation that may be generated using visualization system 105 and/or other visualization and/or monitoring systems. User interface 200 includes host systems 210-211, virtual nodes (VNodes) 220-224, user groups 230-231, users 240-244, and secrets 250-254.

As described in FIG. 1, a visualization system (e.g., visualization system 105) may monitor a computing environment to determine the interactions of various resources within the environment. To monitor the computing environment, the visualization system may rely on agents in the environment to report status information about the various computing elements, may receive reports when a new computing system is initiated or modified, or may receive the information in any other similar manner, including combinations thereof. Once the information is received for the computing environment, a visual representation of the computing environment (e.g., including visual representations of identified host computing systems, identified virtual nodes, identified end users, and identified secrets) may be generated for an administrator or some other responsible user. The information, including visual representations thereof, may be stored in a memory device or the like for later reference. Additional information (e.g., timestamp information, administrator identification) may also be stored.

In the present implementation, the graphical representation includes three separate regions, panels or divisions. A first panel includes the computing resources of the computing environment, including the host systems 210-211 and the virtual nodes 220-224, a second panel includes the user groups 230-231 and users 240-244, and third panel includes secrets 250-254. Based on the information that is collected for the environment, connectors are added to user interface 200 to demonstrate the various interconnections between the computing resources, users, and the secrets. In the present example, connectors are illustrated between virtual nodes 220-222 and users 240-242, and between virtual nodes 223-224 and user group 231. Additionally, connectors are illustrated between users 240-241 and secrets 250-251, and a connector 273 is illustrated between user group 231 and secret 253. Based on the information provided in the user interface 200, a user (e.g., an administrator) may make determinations about the current state of the computing environment. Non-limiting examples disclosed may refer to an administrator as the individual utilizing user interface 200 and a visualization system, though a variety of different operators can utilize such implementations.

In some implementations, an administrator presented with user interface 200 may be provided with options to modify the data that is presented in the user interface (e.g., via modifying data inputs received by a user interface system that can update the display to generate a modified display). In some non-limiting examples, these options may include collapsing or otherwise reducing the amount of information that is provided on the user interface. For instance, an administrator may select to collapse all virtual node instances within host system 211. Accordingly, rather than displaying the information for each of the individual virtual nodes, the lines may be collapsed into the single instance of the host computing system. Also, an administrator can change the connections (e.g., disallowing access for a given user or user group to specific computing resources, virtual nodes, or generating a proposed display providing possible interconnections between computing systems and/or virtual nodes, etc.). Moreover, in some implementations an administrator may create additional/different connections that generate a modified display usable to determine the advisability of granting permissions to specific users and/or user groups, thus utilizing implementations comprising virtualization system 105 and user interface 200 as planning tools for expansion, organizational evolution, distribution of computing resources and/or systems, and other functions. Thus a stored display can be compared to a proposed display received by the user interface system to assist in evaluating and managing the computing environment and access controls therein.

In some examples, an administrator may be provided with a timeline selector, which can be used to select a time period of interest for the computing environment. Based on the period selected by the administrator, user interface 200 may be modified to display interconnections that were present during that particular period, while removing irrelevant connections. In other implementations an administrator may be able to define a specific relationship scheme (e.g., graphically manipulating user interface 200 and/or in other ways) and have the virtualization system respond by indicating whether such a scheme has existed in the past and, if so, during what time period(s). In addition to or in place of the timeline selector, the user may be provided with an interface allowing the user to step through or specify moments of interest for the computing environment. These moments of interest may include the addition of a new node to the computing environment, a change in permissions within the computing environment, the update of a computing system within the computing environment, or any other similar moment of interest. In some implementations, these moments of interest may be provided as a list to the end user, permitting the user to select the particular moment of interest to display the state of the computing environment. For example, if an update were applied to one or more computing resources, the administrator may desire to view the access permissions of the computing environment immediately before the update, and the permissions after the update was applied (or, in the case of projected future configurations, the permissions that will be effected if the update is applied). This may be beneficial in determining access modifications that have occurred or will occur as a result of the update. In some examples, user interface 200 may be used to show the differences between two selected time periods. Accordingly, using the example of the computing system update discussed above, an administrator may select a first moment of interest prior to the update, and a second moment of interest subsequent to the update. Based on the selections, the user interface may provide information about the difference in access permissions between the two moments of interest.

In some implementations, inputs provided by an administrator or user, received by a user interface system, and presented by user interface 200 may select particular items of interest within the computing environment. These items of interest may include specific hosts of interest, virtual machines of interest, users or user groups of interest, or secrets of interest. User interface 200 may be adjusted to reflect particular selections that are identified and/or input by searching for specific items within the environment, by selecting the particular items of interest on user interface 200, or by any other similar means. Accordingly, inputs in one non-limiting example may select host system 211, resulting in the connections from host system 210 being removed from user interface 200, thus permitting an administrator to more easily view the desired interconnections within the environment.

In some examples, the connectors may be displayed using additional identifying indicia (e.g., colors, color coding, patterns, and/or labels on the interconnections) that can assist the administrator viewing user interface 200 in identifying particular traits of a system, its various components, and/or connectors themselves. For example, with reference to connectors between users and secrets, connectors may include identifying indicia that identify the linked resource's type of access to the secret. Referring to the non-limiting example in FIG. 2 illustrating user interface 200, connector 270 between user 240 and secret 250 may comprise a first label indicating read-only access to secret 250, whereas connector 271 between user 241 and secret 251 may comprise a second label indicating read and write access to secret 251. Other types of indicia may also be included, such as deleted permissions, executed permissions, and/or other permissions for secrets 250-254.

Some non-limiting examples illustrate a user interface utilizing three regions, panels or divisions to demonstrate the state of the computing environment. However, it should be understood that other user interface layouts are possible, and are included within the scope of the present invention. These additional layouts may include graphs, lists, trees, maps, and/or other tools and/or indicia that can be used to demonstrate past, present and possible interconnections between computing resources, users, and secret data accessible within the computing environment.

While illustrated in the present example as displaying interconnections between computing resources (hosts and virtual nodes), it should also be understood that in some implementations, connections may be made between the computing resources, for example displaying relationships between identified computing resources and/or virtual nodes. For instance, one or more computing nodes within the computing environment may include “children” nodes (e.g., nodes spawned by other nodes, possibly including permissions that flow therefrom), or nodes for which they are responsible. This may include a virtual node that has spawned one or more additional virtual nodes to provide particular operations. Accordingly, in addition to showing the ownership of computing resources by users, the interface may also display the ownership of computing resources by other nodes in the environment.

FIG. 3 illustrates a method 300 of generating a visual overview of a computing environment according to one implementation. The operations of method 300 are referenced parenthetically in the paragraphs that follow.

As described herein, computing environments may include various computing resources that can be accessed by users with varying levels of permissions. As a computing environment becomes more complex (e.g., additional users and computing resources), identifying the level of access for each of the computing systems to secret data items may be difficult for users and administrators alike. Here, to assist in monitoring a computing environment, a visualization system may be provided to monitor the operational status of the environment and generate a display of the environment's current status. To generate the display, method 300 includes identifying host computing systems and associated virtual nodes of the host computing systems (301). The method further includes identifying end users associated with each virtual node and host computing system (302), and identifying permissions defining each end user's access to secrets in the computing environment (303). These secrets may include usernames, passwords, sensitive files or folders, and/or some other secrets within the computing environment. To identify the status information for the computing environment, the visualization system may employ agents that are configured to monitor for hosts, virtual nodes, users, and secret permissions within the computing environment. These agents may be located on the host computing systems, the virtual nodes, or some other computing resource within the environment, and report information back to the visualization system for display. In other implementations, in addition to or in place of the agents, visualization system may monitor for computing resources in the computing environment to be initiated, updated, or otherwise modified within the environment.

Once the operational information is gathered for the environment, method 300 provides for generating a display of the computing environment, wherein the display comprises interconnections between visual representations of the host computing systems, the virtual nodes, the end users, and the secrets (304). In some implementations, the display may comprise a display similar to that of user interface 200 from FIG. 2, although other examples are possible. In particular, the display generated by method 300 permits an administrator or some other end user to identify associations between the computing resources (hosts and virtual nodes), the end users, and the secrets for the end users. Further, to generate the display, the administrator or other similar user may be provided with options, such as a time period of interest, nodes of interest, users of interest, or some other point of interest within the environment, which can eliminate unwanted connections and visual representations from being visible in the display. Such augmentation of the original display can be implemented through receiving modifying data (305) and updating of the display.

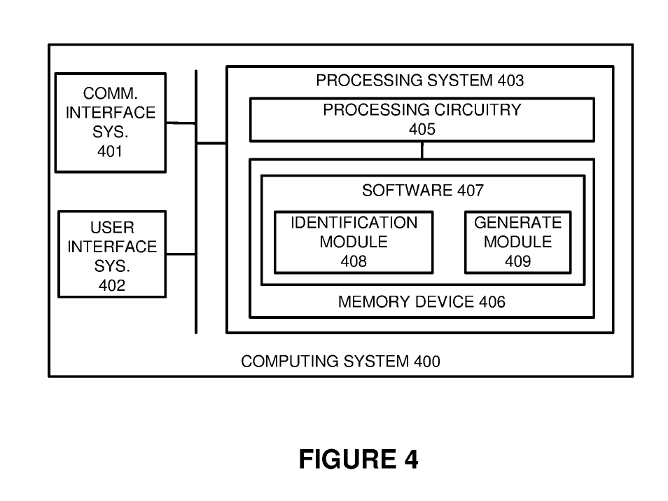

FIG. 4 illustrates a computing system 400 to generate a visual overview of a computing environment according to one implementation. Computing system 400 is representative of any computing system or systems with which the various operational architectures, processes, scenarios, and sequences disclosed herein for a visualization system may be implemented. Computing system 400 may be an example of visualization system 105, although other examples may exist. Computing system 400 may comprise one or more server computing systems, desktop computing systems, routers, gateways, switches, and other similar computing elements, including combinations thereof. Computing system 400 comprises communication interface system 401, user interface system 402, and processing system 403. Processing system 403 is linked to communication interface system 401 and user interface system 402. Processing system 403 includes processing circuitry 405 and memory device 406 that stores operating software 407. Memory device 406 may also store past visualization data and displays, as well as other data utilized in some implementations.

Communication interface system 401 comprises components that communicate over communication links, such as network cards, ports, radio frequency (RF) transceivers, processing circuitry and software, or some other communication devices. Communication interface system 401 may be configured to communicate over metallic, wireless, or optical links. Communication interface system 401 may be configured to use Time Division Multiplex (TDM), Internet Protocol (IP), Ethernet, optical networking, wireless protocols, communication signaling, or some other communication format—including combinations thereof.

User interface system 402 comprises components that interact with a user (e.g., an administrator) to receive inputs and to present media and/or information (e.g., including user interface 200). User interface system 402 may include a speaker, microphone, buttons, lights, display screen, touch screen, touch pad, scroll wheel, communication port, or some other user input/output apparatus—including combinations thereof. One or more components of user interface system 402 may be omitted in some examples.

Processing circuitry 405 comprises microprocessor and other circuitry that retrieves and executes operating software 407 from memory device 406. Memory device 406 comprises a non-transitory storage medium, such as a disk drive, flash drive, data storage circuitry, or some other memory apparatus. Processing circuitry 405 is typically mounted on one or more circuit boards that may also hold memory device 406 and at least portions of communication interface system 401 and user interface system 402. Operating software 407 comprises computer programs, firmware, or some other form of machine-readable processing instructions (e.g., a computer readable storage medium having instructions stored thereon that, when executed by the one or more processors, causes the management system to operate as described herein). Operating software 407 includes identification module 408 and generate module 409, although any number of software modules may provide the same operation. Operating software 407 may further include an operating system, utilities, drivers, network interfaces, applications, or some other type of software. When executed by processing circuitry 405, operating software 407 directs processing system 403 to operate computing system 400 as described herein.

In particular, identification module 408 directs processing system 403 to identify host computing systems within a computing environment, to identify virtual nodes executing on the host computing systems, to identify users associated with the host computing systems and virtual nodes, and to identify secret permissions associated with each end user. To identify the information, computing system 400 may communicate with one or more agents that provide reports of the operations within the environment, may obtain the information when new hosts and nodes are initiated within the environment, may be manually provided with information by an administrator or other user, or may receive operational information in any other manner, including combinations thereof.

Once the information about the computing environment is gathered, generate module 409 directs processing system 403 to generate a display of the computing environment, wherein the display comprises interconnections between visual representations of the host computing systems, the virtual nodes, the end users, and the secret permissions. This display may be similar to user interface 200 from FIG. 2, although other examples may exist.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts. It is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of managing computing resources in a computing environment, the method comprising:
identifying host computing systems in the computing environment;
identifying virtual nodes executing on the identified host computing systems;
identifying end users associated with each identified host computing system and each identified virtual node;
identifying permissions to identified secrets in the computing environment for each identified end user; and
generating a display of the computing environment on a user interface system, wherein the display comprises a plurality of interconnections illustrating connections between visual representations of the identified host computing systems, the identified virtual nodes, the identified end users, and the identified secrets.

2. The method of claim 1 wherein one or more of the interconnections comprise indicia providing information about the type of each interconnection.

3. The method of claim 2 wherein the indicia comprise one or more of the following:
patterns;
color coding of the one or more interconnections;
labels on the one or more interconnections.

4. The method of claim 1 wherein the display further comprises relationships between identified computing systems and/or virtual nodes.

5. The method of claim 1 further comprising:
receiving modifying data; and
updating the display to generate a modified display.

6. The method of claim 5 wherein the modifying data comprises possible interconnections between identified computing systems, identified virtual nodes, identified end users and identified secrets.

7. The method of claim 1 further comprising:
storing the display in a memory device; and
comparing the stored display to a proposed display received by the user interface system.

8. The method of claim 1 wherein a visualization system identifies and provides to the user interface system the identified computing systems, identified virtual nodes, identified end users and identified secrets.

9. A management system for managing computing resources in a computing environment, the system comprising:
one or more processors;
a computer readable storage medium having instructions stored thereon that, when executed by the one or more processors, cause the management system to:
identify host computing systems in the computing environment;
identify virtual nodes executing on the host computing systems;
identify end users associated with each identified host computing system and each identified virtual node;
identify permissions to identified secrets in the computing environment for each identified end user;
identify connections between identified host computing systems, the identified virtual nodes, the identified end users, and the identified secrets; and
generate a display of the computing environment on a user interface system, wherein the display comprises a plurality of interconnections illustrating connections between visual representations of the identified host computing systems, the identified virtual nodes, the identified end users, and the identified secrets.

10. The system of claim 9 wherein one or more of the interconnections comprise indicia providing information about the type of each interconnection.

11. The system of claim 10 wherein the indicia comprise one or more of the following:
patterns;
color coding of the one or more interconnections;
labels on the one or more interconnections.

12. The system of claim 9 wherein the display further comprises relationships between identified computing systems and/or virtual nodes.

13. The system of claim 9 wherein the instructions stored on the computer readable storage medium, when executed by the one or more processors, further cause the management system to:
receive modifying data; and
update the display to generate a modified display.

14. The system of claim 13 wherein the modifying data comprises possible interconnections between identified computing systems, identified virtual nodes, identified end users and identified secrets.

15. The system of claim 9 wherein the instructions stored on the computer readable storage medium, when executed by the one or more processors, further cause the management system to:
store the display in a memory device; and
compare the stored display to a proposed display received by the user interface system.

16. The system of claim 9 wherein a visualization system identifies and provides to the user interface system the identified computing systems, identified virtual nodes, identified end users and identified secrets.

17. A method of managing computing resources in a computing environment, the method comprising:
identifying host computing systems in the computing environment;
identifying virtual nodes executing on the identified host computing systems;
identifying end users associated with each identified host computing system and each identified virtual node;
identifying permissions to identified secrets in the computing environment for each identified end user;
generating a first modifiable display of the computing environment as a user interface, wherein the first modifiable display illustrates connections between visual representations of the identified host computing systems, the identified virtual nodes, the identified end users, and the identified secrets;
receiving modifying data; and
updating the first modifiable display to generate a second modifiable display.

18. The method of claim 17 further comprising comparing the first modifiable display to the second modifiable display.

19. The method of claim 18 wherein the illustrated connections comprise indicia providing information about the type of each connection.

20. The method of claim 19 wherein the indicia comprise one or more of the following:
patterns;
color coding of the one or more interconnections;
labels on the one or more interconnections.
